(19) United States
(12) Patent Application Publication
(10) Pub. No.: US 2008/0122991 A1
(43) Pub. Date: May 29, 2008

(54) Portable information product having projection device with digital light processing

(76) Inventor: Hao-Wen Chen, Taipei City (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/907,210

(22) Filed: Oct. 10, 2007

(30) Foreign Application Priority Data
Nov. 29, 2006 (TW) 95221057

(51) Int. Cl. H04N 5/64

(52) U.S. Cl. 348/744; 348/E05.128

(57) ABSTRACT

A portable information product, such as a cellular phone, a portable computer, a personal digital assistant, having a DLP projection device, and further comprising a data processing device and a DLP projection device is proposed. The data processing device has a main circuit module for processing data thereof and forming an image output signal from the data. The DLP projection device is disposed in the data processing device and electrically connects to the main circuit module. The DLP projection device has a light source and a DLP projector. The light source generates a light. The light and the image output signal are transmitted to the DLP projector to form an image, and the DLP projector projects the image outside of the data processing device. As a result, the data of the data processing device is easier for multiple users to view.

### BACKGROUND OF THE INVENTION

1. Field of the Invention

The present invention relates to a portable information product, and more particularly, to a portable information product having a projection device with digital light processing.

2. Background of the Invention

Portable information products are becoming more and more popular. For example, cellular phones, portable computers, and personal digital assistants are all small in size and have a variety of functions. It is easy for users to take portable information products with them to help them organize their daily affairs or offer a source of entertainment at any time.

A conventional portable information product displays data on a display device. The display device of the conventional portable information product has a limited size and is only designed for a single user to view. As such, it is difficult for others to view the display at the same time. It lacks practicality if a user wants to show information stored on the portable information product to others, if, as an example, they are in a conference with several people.

Furthermore, the projective technology of digital light processing (DLP) has been the major technology used for projecting and displaying information for some time now. The projective technology of DLP is formed from a kind of elements known as Micro-Electro-Mechanical Systems (MEMS), such as a digital micro-mirror device (DMD) developed in 1987 by Texas Instruments Corp.

A digital micro-mirror device (DMD) has a large amount of sub-mini optical switches. The shape of a sub-mini optical switch is a tetrahedral, and the square measure of a sub-mini optical switch is about 14 micrometers. The digital micro-mirror device can receive a data character signal and generate an optical character signal.

In business, a projection device with digital light processing is used to digitally process a light source. The imaging theorem of the DMD is as follows: a color wheel with four colors is used to receive a light and divide the light into four color lights that are then projected onto the DMD chip. The sub-mini optical switches of the DMD reflect out unnecessary color light via the digital signal “o” and project the necessary color light to a lens via the digital signal “1” to generate an image.

As a result of the prior art portable information product being limited to offering only small screens, it isn't possible for multiple users to view the screen conveniently at the same time. Therefore, the inventor proposes a portable information product having a projection device with digital light processing that allows multiple users to view the screen at the same time.

Accordingly, as discussed above, the conventional portable information product still has some drawbacks that could be improved upon. The present invention aims to resolve the drawbacks in the prior art.

### SUMMARY OF THE INVENTION

The primary object of the invention is therefore to specify a portable information product having a projection device with digital light processing (DLP projection device), wherein the DLP projection device is disposed in a data processing device, and the DLP projection device outputs an image output signal formed by the data processing device outside of the data processing device, so that others can view the data of the data processing device more easily.

According to the invention, the object is achieved via a portable information product having a DLP projection device. The portable information product comprises a data processing device and a DLP projection device. The data processing device has a main circuit module for processing data thereof and forming an image output signal from the data. The DLP projection device is disposed in the data processing device and electrically connects to the main circuit module. The DLP projection device has a light source and a projector with digital light processing (DLP projector). The light source generates a light. The light and the image output signals are transmitted to the DLP projector to form an image, and the DLP projector projects the image outside of the data processing device.

The DLP projection device is disposed in the data processing device. As such, the image output signal formed by the data processing device is outputted via the DLP projection device so that others can view the data of the data processing device more easily.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic block diagram of a first embodiment of an interior system according to a portable information product having the DLP projection device of the present invention;

FIG. 2 is a schematic block diagram of a second embodiment of an interior system according to a portable information product having the DLP projection device of the present invention;

FIG. 3 is a perspective view of a first embodiment according to a portable information product having the DLP projection device of the present invention;

FIG. 4 is a perspective view of a second embodiment according to a portable information product having the DLP projection device of the present invention;

FIG. 5 is a perspective view of a third embodiment according to a portable information product having the DLP projection device of the present invention; and

FIG. 6 is a perspective view of a fourth embodiment according to a portable information product having the DLP projection device of the present invention.

### DETAILED DESCRIPTION OF THE EMBODIMENTS

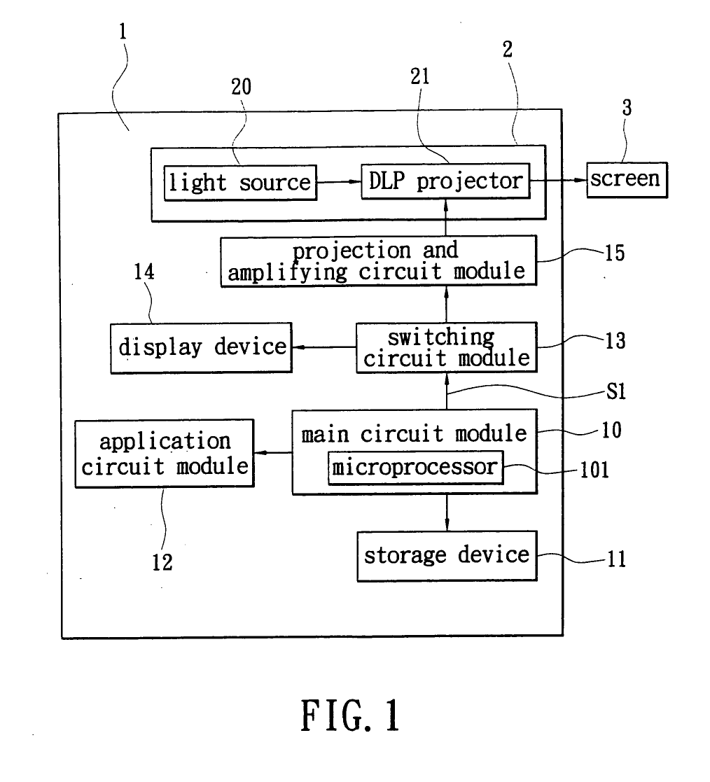

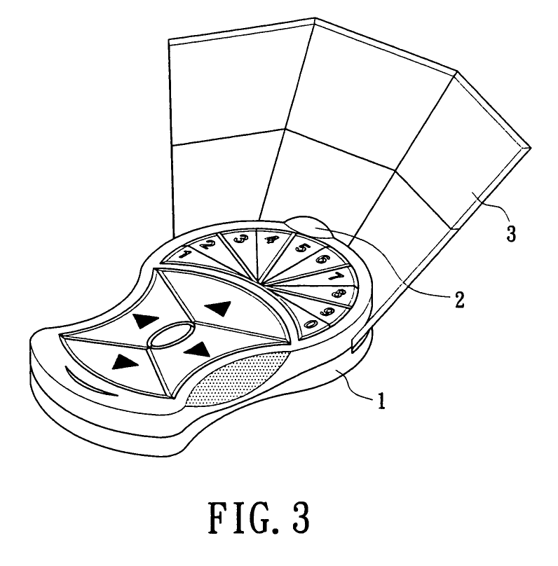

The present invention provides a portable information product having a projection device with digital light processing (a DLP projection device). FIG. 1 shows a first embodiment of an interior system according to a portable information product having a DLP projection device of the present invention. As shown in FIGS. 3-6, the portable information product may be a cellular phone, a portable computer, a personal digital assistant, or any type of portable information product. The portable information product comprises a data processing device 1 and a DLP projection device 2.

The data processing device 1 has a main circuit module 10. The main circuit module 10 has a microprocessor 101, various essential program processors (not shown), various essential memories (not shown), and other electronic elements, for processing data thereof and forming an image output signal S1 from the data.

The data processing device 1 has a storage device 11 and an application circuit module 12. The storage device 11 may be a hard disk drive, a card reader, or any type of device capable of storing data. The storage device 11 electrically connects to the main circuit module 10 for storing data for the data processing device 1. The application circuit module 12 may be a charging circuit module, an audio circuit module, or any other type of functional application circuit module. The application circuit module 12 electrically connects to the main circuit module 10 for processing data stored on the data processing device 1.

The DLP projection device 2 is disposed in the data processing device 1 and electrically connects to the main circuit module 10. The projection device 2 has a light source 20 and a projector with digital light processing 21 (DLP projector). The light source 20 may be a light emitting diode (LED) for generating light. The DLP projector 21 is used to process the light source via a digital micro-mirror device (DMD). The imaging theorem of the DMD is as follows: a color wheel with four colors is used to receive the light and divide the light into four color lights that are projected onto the DMD chip. The sub-mini optical switches of the DMD reflect out unnecessary color light by the digital signal “o” and project the necessary color light to a lens via the digital signal “1” to generate an image.

As shown in FIG. 1, the data processing device 1 also has a switching circuit module 13, a display device 14, and a projection and amplifying circuit module 15. The switching circuit module 13 electrically connects between the main circuit module 10 and the DLP projection device 2, and between the main circuit module 10 and the display device 14. The display device 14 may be a liquid crystal display (LCD). The projection and amplifying circuit module 15 electrically connects between the main circuit module 10 and the DLP projector 21 of the DLP projection device 2, and is disposed between the switching circuit module 13 and the DLP projector 21, for processing and amplifying the image output signal S1 from the main circuit module 10.

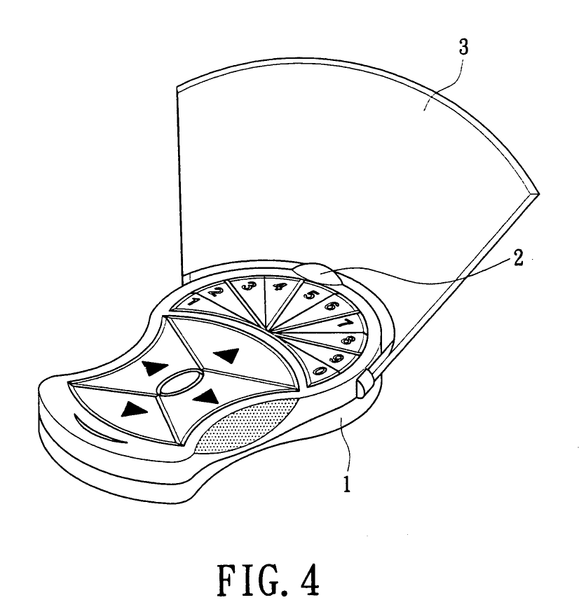

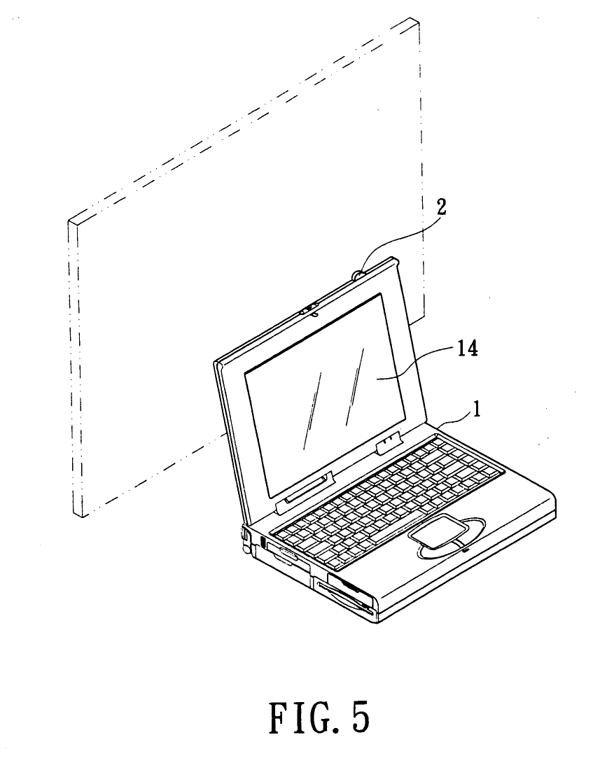

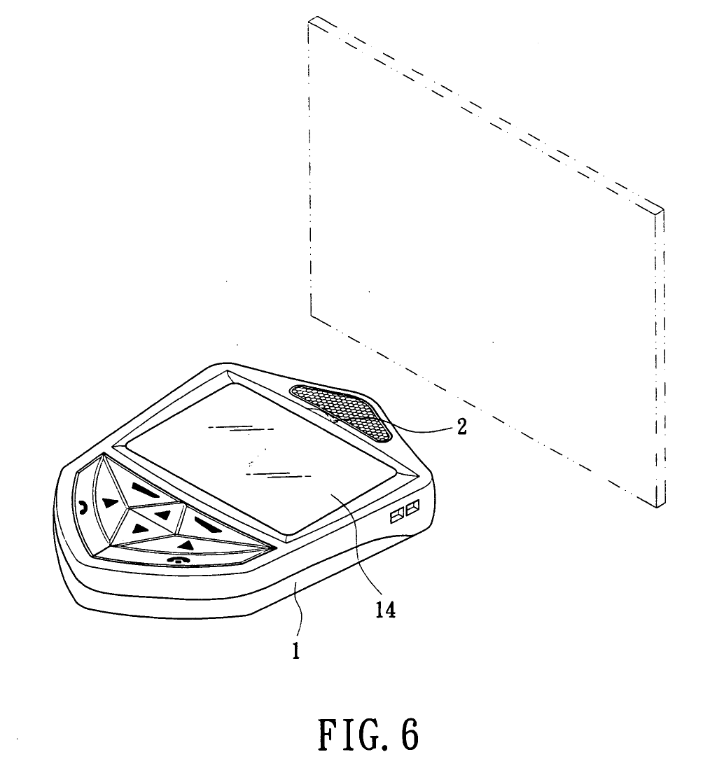

The portable information product having a built-in projection device of the present invention uses the DLP projection device 2 and/or the display device 14 to display the image output signal S1 formed from the data thereof. The image output signal S1 is alternatively transmitted to the DLP projection device 2 and/or the display device 14 through the switching circuit module 13. The portable information product may further comprise a screen 3 for projecting images thereon. As shown in FIG. 3, the screen 3 retrievably connects to the data processing device 1. As shown in FIG. 4, the screen 3 detachably assembles to the data processing device 1. When a user uses the DLP projection device 2 to display the data of the data processing device 1, the image output signal S1 is transmitted to the DLP projector 21 via the projection and amplifying circuit module 15, and the light source 20 generates a light. The light and the image output signal S1 are transmitted to the DLP projector 21 to form an image, and the DLP projector 21 projects the image onto the screen 3 outside of the data processing device 1. As a result, more people can view the image simultaneously. As shown in FIG. 5 and FIG. 6, the portable information product may also not have a screen for projection. In this case, the DLP projector 21 directly projects the image onto an appropriate surface outside of the data processing device 1. The user may also use the display device 14 to display data stored on the data processing device 1, or use the DLP projection device 2 and the display device 14 to display data stored on the data processing device 1 simultaneously.

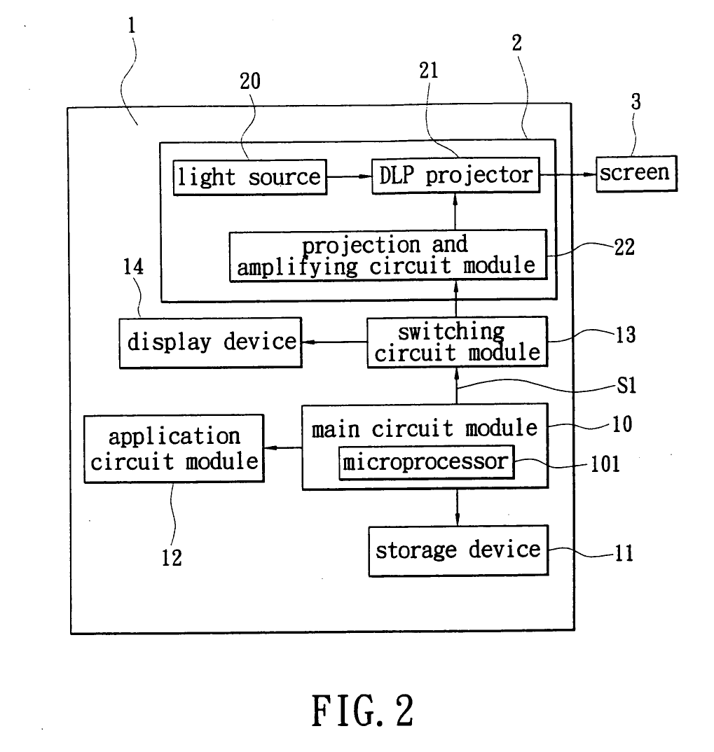

FIG. 2 shows a second embodiment of an interior system according to a portable information product having a DLP projection device of the present invention. The difference between FIG. 2 and FIG. 1 is the projection and amplifying circuit module 22. In FIG. 2, the DLP projection device 2 has a projection and amplifying circuit module 22 electrically connected between the main circuit module 10 and the DLP projector 21 of the DLP projection device 2, and is disposed between the switching circuit module 13 and the DLP projector 21. The image output signal S1 is transmitted to the DLP projector 21 via the projection and amplifying circuit module 22. Therefore, the projection and amplifying circuit module 22 may be integrated with the DLP projection device 2 or the data processing device 1.

As indicated above, the portable information product having a built-in projection device of the present invention has the following advantages:

(1) The DLP projection device is disposed in the data processing device, so that the image output signal S1 formed by the data processing device is outputted via the DLP projection device, so that data stored on the data processing device is easier to view.

(2) The screen retrievably connects to the data processing device, or the screen detachably assembles onto the data processing device, or the portable information product may not have a screen, so the portable information product is more convenient for multiple users to view images stored on the data processing device.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A portable information product having a projection device with digital light processing, comprising:
a data processing device, further comprising:
a storage device for storing data of the data processing device;
a main circuit module electrically connecting to the storage device for processing data of the data processing device and forming an image output signal from the data;
an application circuit module electrically connecting to the main circuit module, wherein the main circuit module is a charging circuit module or an audio circuit module;
a display device;
a projection and amplifying circuit module;
a switching circuit module electrically connecting to the main circuit module, the projection and amplifying circuit module and the display device for receiving the image output signal and alternatively transmitting the image output signal to the projection and amplifying circuit module and/or the display device;
a projection device with digital light processing having a light source and a projector with digital light processing, the light source generating a light, the projector with digital light processing electrically connecting to the projection and amplifying circuit module, the light and the image output signal being transmitted to the projector with digital light processing to form an image, and the projector with digital light processing projecting the image outside of the data processing device; and
a screen for projection, wherein the screen retrievably connects to the data processing device or detachably assembles to the data processing device.

2. The portable information product as claimed in claim 1, wherein the portable information product is a cellular phone.

3. The portable information product as claimed in claim 1, wherein the portable information product is a portable computer.

4. The portable information product as claimed in claim 1, wherein the portable information product is a personal digital assistant.

5. The portable information product as claimed in claim 1, wherein the portable information product is a multimedia player.

6. The portable information product as claimed in claim 1, wherein the main circuit module of the data processing device has a microprocessor for processing the data of the data processing device.
